(19) United States
(12) Patent Application Publication
(10) Pub. No.: US 2010/0274694 A1
(43) Pub. Date: Oct. 28, 2010

(54) RELAY SERVER, CONTENT DISTRIBUTION SYSTEM AND CONTENT DISTRIBUTION METHOD

(75) Inventor: Junichi Yamaguchi, Tokyo (JP)

Correspondence Address: MICHAUD-Kinney Group LLP, 306 INDUSTRIAL PARK ROAD, SUITE 206, MIDDLETOWN, CT, 06457, US

(73) Assignee: NTT DOCOMO, INC., Tokyo (JP)

(21) Appl. No.: 12/765,214

(22) Filed: Apr. 22, 2010

(30) Foreign Application Priority Data
Apr. 24, 2009 (JP) 2009-105940

(51) Int. Cl. G06F 15/16; G06Q 30/00; G06Q 50/00

(52) U.S. Cl. 705/34; 709/246

(57) ABSTRACT

To enable content distributed to a user terminal to be optimized and distributed on the network side in accordance with various conditions on the user terminal side without increasing the processing load on the content server side. A gateway server (relay server) acquires content in an editable form from the content server, and edits the acquired content based on an editing condition of the user terminal, and distributes the edited content to the user terminal.

This application is based on the Japanese Patent Application No. 2009-105940 filed on Apr. 24, 2009, the entire content of which is expressly incorporated by reference herein.

### BACKGROUND OF THE INVENTION

1. Field of the invention

The present invention relates to a relay server, content distribution system and content distribution method for distributing contents to user terminals.

2. Description of the Prior Art

Conventionally, content distribution systems have been known in which a user selects optimal content in accordance with a charging form of the user terminal, and thereby optimizes the content distributed to the user terminal from a content provider (for example, Japanese Patent Publication No. 2007-129472).

In the content distribution systems, when the charging form of the user terminal is a flat-rate system in which a fixed fee is charged irrespective of communication data amounts, the user selects content with high added value such as high resolution and moving images. Meanwhile, when the charging form of the user terminal is a non-flat-rate system in which a fee is charged in accordance with communication data amounts, the user selects content with low added value such as low resolution and still images. The content provider distributes the content selected by the user to the user terminal. In such a content distribution system, the user needs to recognize the charging form of the user and select the content corresponding to the recognized charging form, and therefore, the processing load increases on the user terminal side.

Then, in the above-mentioned content distribution system, in order to reduce the processing load on the user terminal side, it is considered that the content to distribute to the user terminal is optimized in accordance with the charging form of the user terminal on the content server side for providing the content.

However, when the content is optimized on the content server side, the content server needs to acquire the charging form of the user terminal and select the content corresponding to the charging form of the user terminal, and therefore, the processing load increases on the content server side.

Such problems are not limited to the case of distributing the content corresponding to the charging form of the user terminal, and schemes for optimizing contents distributed to user terminals have been desired without increasing not only the processing load on the user terminal side but also the processing load on the content server side.

### SUMMARY OF THE INVENTION

The present invention was made in view of the respects, and in some embodiments a relay server, content distribution system and content distribution method enable content distributed to a user terminal to be optimized on the network side in accordance with various conditions on the user terminal side without increasing the processing load on the content server side.

A relay server of the invention comprises a content acquiring section that acquires content in an editable form from a content server, in accordance with a content distribution request from a user terminal, and a content distributing section that edits the content acquired by the content acquiring section based on an editing condition of the user terminal, and distributes the edited content to the user terminal.

According to this configuration, the relay server edits the content acquired from the content server based on the editing condition of the user terminal and distributes the edited content to the user terminal. Consequently, it is possible to optimize the content on the network side in accordance with various conditions of the user terminal side without increasing the processing load on the content server side.

Further, it is a feature of some embodiments that in the relay server, the content acquiring section acquires content to be edited into content for a flat-rate system and content for a non-flat-rate system, and that the content distributing section distributes the content for the flat-rate system to the user terminal when a charging form of the user terminal is the flat-rate system, while distributing the content for the non-flat-rate system to the user terminal when the charging form of the user terminal is the non-flat-rate system.

According to this configuration, the relay server edits the content acquired from the content server based on whether the charging form of the user terminal is the flat-rate system or non-flat-rate system. Therefore, the content server is capable of distributing high-value added content with high capacity irrespective of whether or not the charging form of the user terminal is a non-flat-rate system. Further, the relay server is capable of distributing high-value added content with high capacity to a user terminal such that the charging form is the flat-rate system, while distributing content with low data capacity to a user terminal such that the charging form is the non-flat-rate system.

Further, in some embodiments, the relay server may distribute a moving image as the content for the flat-rate system, and a still image as the content for the non-flat system.

Furthermore, it is a feature of some embodiments that in the relay server, the content acquiring section acquires content to be edited into content that includes information for a predetermined age targeted for a user of the predetermined age or more and content that does not include the information for the predetermined age, and that the content distributing section distributes the content that includes the information for the predetermined age to the user terminal when a user's age of the user terminal is a predetermined age or more, while distributing the content that does not include the information for the predetermined age when the user's age of the user terminal is less than the predetermined age.

According to this configuration, it is possible to edit the content acquired from the content server in accordance with the user's age in the relay server, and the content provider is capable of freely distributing contents without undergoing limitations by the user's age.

Further, it is a feature of some embodiments that in the relay server, the content acquiring section acquires content to be edited into content that includes information for a predetermined area targeted for a user locating in the predetermined area and content that does not include the information for the predetermined area, and that the content distributing section distributes the content that includes the information for the predetermined area to the user terminal when a locating area of the user terminal corresponds to the predetermined area, while distributing the content that does not include the information for the predetermined area when the locating area of the user terminal does not correspond to the predetermined area.

According to this configuration, it is possible to edits the content acquired from the content server in accordance with the locating area of the user terminal in the relay server, and the content for a specific area can be distributed reliably to the user terminal that locates in the corresponding area, while being prevented from being distributed to a user terminal that does not locate in the corresponding area.

Further, a content distribution system according to some embodiments is a content distribution system provided with a user terminal for transmitting a content distribution request, a content server for distributing content, and a relay server for relaying content transmitted from the content server to the user terminal, and is characterized in that the content server distributes content in an editable form, in accordance with a content distribution request from the user terminal, and that the relay server receives the content in the editable form from the content server, and edits the content in the editable form based on an edit condition, and distributes the edited content to the user terminal.

Furthermore, a content distribution method according to some embodiments is characterized by having the steps of transmitting a content distribution request transmitted from a user terminal to a content server, acquiring content in an editable form from the content server, in accordance with the content distribution request from the user terminal, and editing the content acquired by the content acquiring section based on an editing condition of the user terminal, and distributing the edited content to the user terminal.

According to some embodiments, it is possible to provide a relay server, content distribution system and content distribution method enabling content distributed to a user terminal to be optimized on the network side in accordance with various conditions on the user terminal side without increasing the processing load on the content server side.

### BRIEF DESCRIPTION OF THE DRAWINGS

The various features of novelty which characterize the invention are pointed out with particularity in the claims attached to and forming a part of this specification. For a better understanding of the invention, its operating advantages, and specific objects attained by its use, reference should be had to the accompanying drawing and descriptive matter in which there is illustrated and described a preferred embodiment of the invention.

FIG. 1 is a schematic diagram of a content distribution system according to some embodiments;

FIG. 2 is a configuration diagram of a gateway server according to some embodiments;

FIG. 3 contains views to explain (a) content in the editable form according to Embodiment 1 of the invention, (b) content for a flat-rate system according to Embodiment 1 of the invention, and (C) content for a non-flat-rate system according to some embodiments;

FIG. 4 is a sequence diagram illustrating a content distribution method according to some embodiments;

FIG. 5 is a flowchart illustrating the operation of the gateway server according to some embodiments; and

FIG. 6 contains views to explain (a) content in the editable form according to Embodiment 2 of the invention, (b) content for a flat-rate system according to Embodiment 2 of the invention, and (C) content for a non-flat-rate system according some embodiments.

### DESCRIPTION OF THE PREFERRED EMBODIMENTS

Embodiments of the invention will specifically be described below with reference to accompanying drawings.

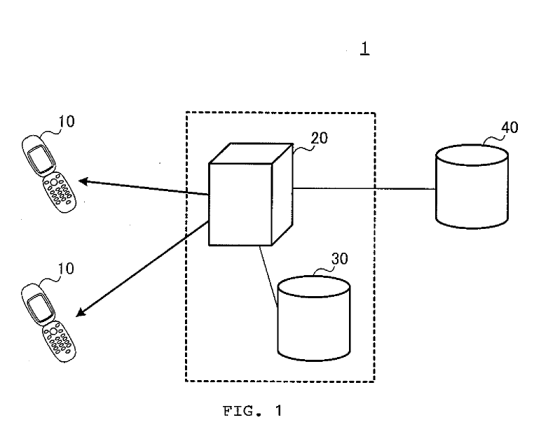

FIG. 1 is a schematic diagram of a content distribution system according to some embodiments. As shown in FIG. 1, the content distribution system 1 includes user terminals 10, gateway server 20, client managing system 30 and content server 40.

For example, the user terminals 10 are mobile terminals, and connected to the gateway server 20 via a base station and the like (not shown in the figure). The gateway server 20 (relay server) is a server of a telecommunications carrier that relays communications between the user terminals 10 and content server 40. The client managing system 30 is a system that manages user attributes (for example, charging form, user's age, etc.) of the user terminals 10 subscribing to the telecommunications carrier, and is connected to the gateway server 20. Further, the client managing system 30 is accessible from the gateway server 20 managed by the telecommunications carrier, but is not accessible from the content server 40 that is not managed by the telecommunications carrier. The content server 40 is a server that distributes contents to the user terminals 10 via the gateway server 20.

In such a content distribution system 1, the gateway server 20 (relay server) acquires editable content from the content server 40, edits the editable content acquired from the gateway server based on a predetermined editing condition, and distributes the edited content to the user terminal 10. Accordingly, in the content distribution system 1, it is possible to optimize the content distributed to the user terminal 10 on the network side in accordance with various conditions on the user terminal 10 side without increasing the processing load on the content server side.

The present embodiment describes an example that in the content distribution system 1, the gateway server 20 edits the content to distribute to the user terminal 10 based on whether the charging form of the user terminal 10 is a flat-rate system or non-flat-rate system.

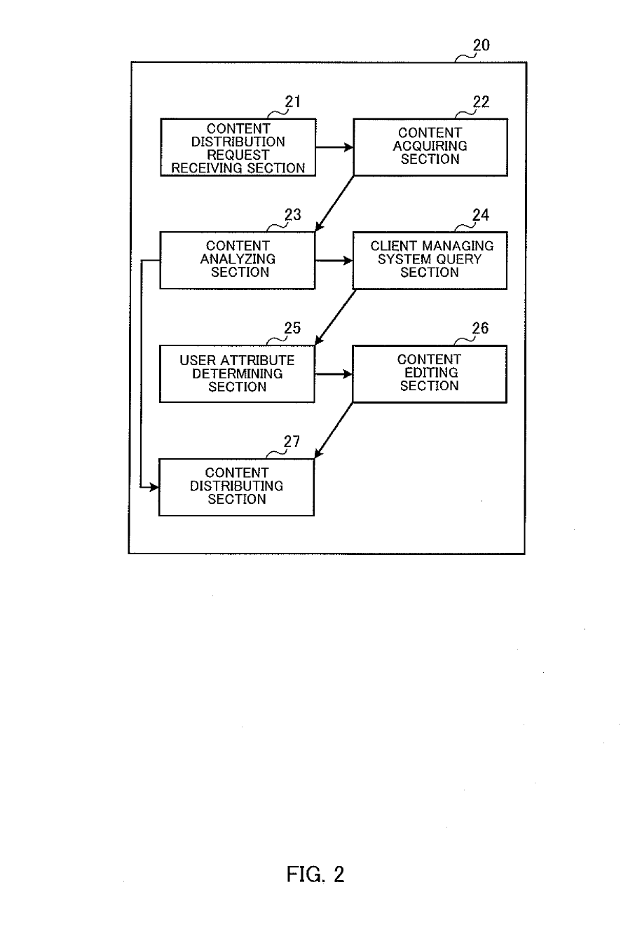

FIG. 2 is a configuration diagram of the gateway server 20 according to some embodiments. As shown in FIG. 2, the gateway server 20 includes a content distribution request receiving section 21, content acquiring section 22, content analyzing section 23, client managing system query section 24, user attribute determining section 25, content editing section 26 (content distributing section), and content distributing section 27 (content distributing section).

The content distribution request receiving section 21 receives a content distribution request and identification information (for example, the telephone number or subscription number) of the user terminal 10 from the user terminal 10. Herein, the content distribution request is to request the content server 40 to distribute the content, and includes the identification information (for example, URL: Uniform Resource Location) of the content server 40 and content. Further, the content distribution request receiving section 21 transfers the content distribution request received from the user terminal 10 to the content server 40.

The content acquiring section 22 acquires the content that is distributed from the content server 40 in accordance with the above-mentioned content distribution request.

The content analyzing section 23 analyzes whether the content acquired by the content acquiring section 22 is content in the editable form. When the analysis result shows the content in the editable form, the content analyzing section 23 notifies the client managing system query section 24 of the analysis result, while notifying the content distributing section 27 of the analysis result when the analysis result does not show the content in the editable form.

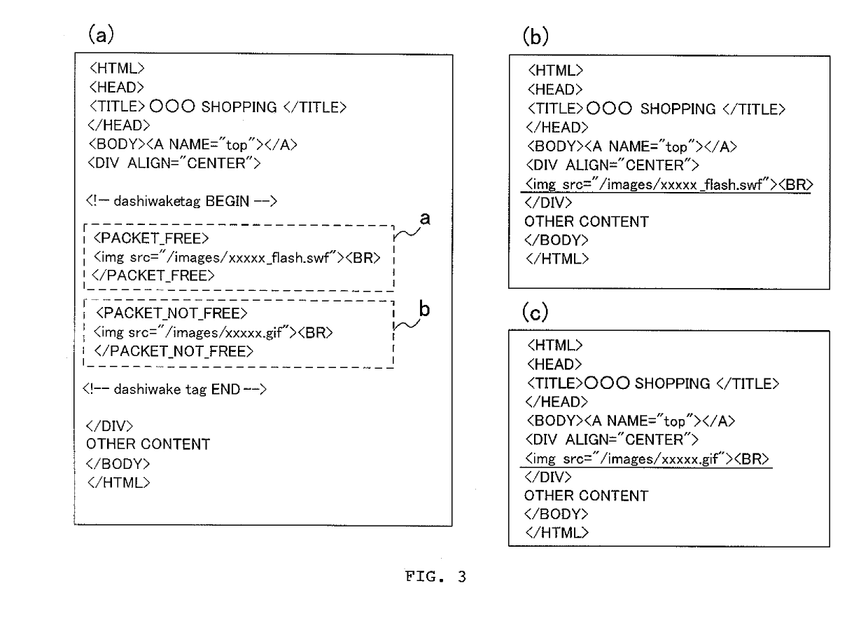

In some embodiments, the content in the editable form is an HTML file including a tag area to edit the content. More specifically, as shown in FIG. 3(a), the content to be edited into the content for the flat-rate system and the content for the non-flat-rate system includes a tag “a” to distribute the content for the flat-rate system and a tag “b” to distribute the content for the non-flat-rate system.

In the tag “a”, moving image content (img src=“/images/xxxxx_flash.swf”) is designated as the content for the flat-rate system. In addition, as the content for the flat-rate system, as well as the moving image content, content with high capacity such as high-resolution content may be designated.

Meanwhile, in the tag “b”, still image content (img src=“/images/xxxxx.gif”) is designated as the content for the non-flat-rate system. In addition, as the content for the non-flat-rate system, as well as the still image content, content with low capacity such as low-resolution content may be designated.

When the analysis result in the content analyzing section 23 shows the content in the editable form, the client managing system query section 24 refers to the client managing system 30 for the charging form of the user terminal 10 using, as a key, the identification information of the user terminal 10 included in the content distribution request from the user terminal 10. In addition, the client managing system query section 24 may acquire the charging form of the user terminal 10 from the contract information stored in a storing section (not shown in the figure) inside the gateway server 20 without referring to the client managing system 30.

The user attribute determining section 25 determines whether the charging form of the user terminal 10 acquired in the client managing system query section 24 is the flat-rate system or the non-flat-rate system. When the charging form of the user terminal 10 is the flat-rate system, the user attribute determining section 25 determines to distribute the content for the flat-rate system, while determining to distribute the content for the non-flat-rate system, when the charging form of the user terminal 10 is the non-flat-rate system.

The content editing section 26 edits the editable content acquired from the content server 40 according to the determination result by the user attribute determining section 25.

More specifically, when the user attribute determining section 25 determines to distribute the content for the flat-rate system, as shown in FIG. 3(b), the content editing section 26 edits the HTML file so as to distribute the flat-rate content (img src=“/images/xxxxx_flash.swf”) designated by the tag “a” for the flat-rate system. Meanwhile, when the user attribute determining section 25 determines to distribute the content for the non-flat-rate system, as shown in FIG. 3(c), the content editing section 26 edits the HTML file so as to distribute the non-flat-rate content (img src=“/images/xxxxx.gif”) designated by the tag “b” for the non-flat-rate system.

The content distributing section 27 distributes the content edited by the content editing section 26 to the user terminal 10. Further, when the analysis result in the content analyzing section 23 does not show the content in the editable form, the content distributing section 27 distributes the content acquired from the content server 40 to the user terminal 10 without any editing.

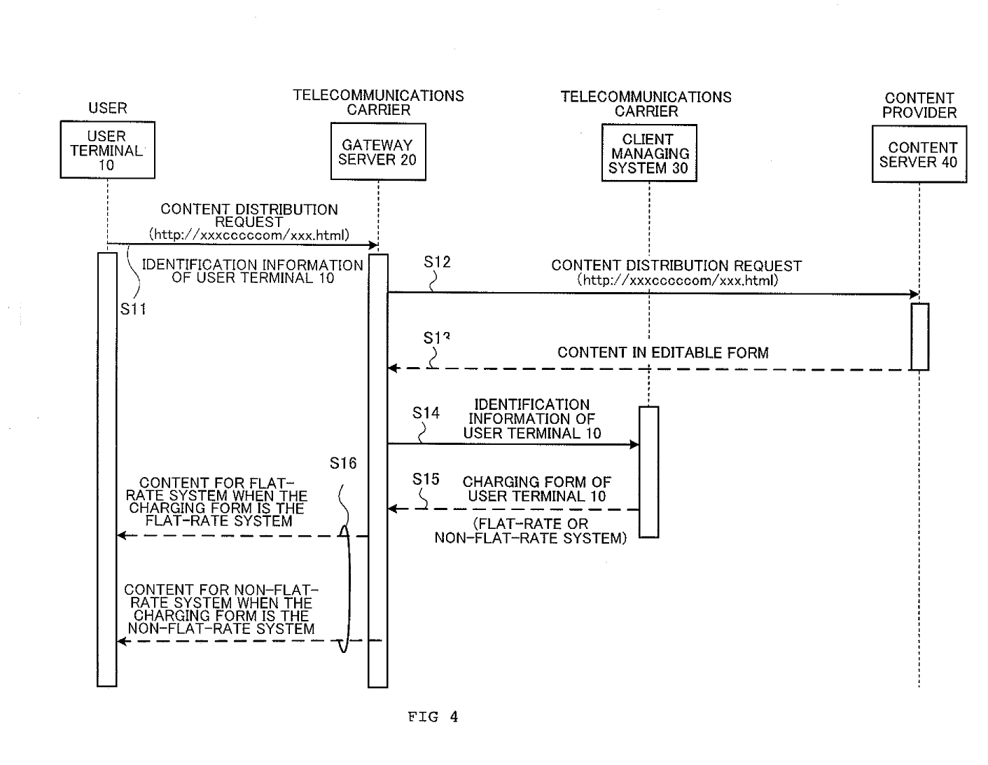

Described next is a content distribution method in the content distribution system 1 according to some embodiments that is configured as described above. FIG. 4 is a sequence diagram illustrating the content distribution method according to some embodiments.

As shown in FIG. 4, the user terminal 10 transmits a content distribution request for the content server 40 and the identification information of the user terminal 10 to the gateway server 20 (step S11).

The gateway server 20 transfers the content distribution request received from the user terminal 10 to the content server 40 (step S12).

The content server 40 transmits the content designated in the content distribution request to the gateway server 20 (step S13). In addition, the content server 40 is capable of transmitting the content in the editable form and content in the non-editable form to the gateway server 20, and for purposes of example, is assumed to transmit the content in the editable form.

The gateway server 20 refers to the client managing system 30 for the charging form of the user terminal 10, using as a key the identification information of the user terminal 10 included in the content distribution request received in step S11 (step S14).

The client managing system 30 transmits a query result of the charging form of the user terminal 10 (step S15).

The gateway server 20 distributes the content for the flat-rate system to the user terminal 10 when the charging form of the user terminal 10 is the flat-rate system, while distributing the content for the non-flat-rate system to the user terminal 10 when the charging form of the user terminal 10 is the non-flat-rate system (step S16).

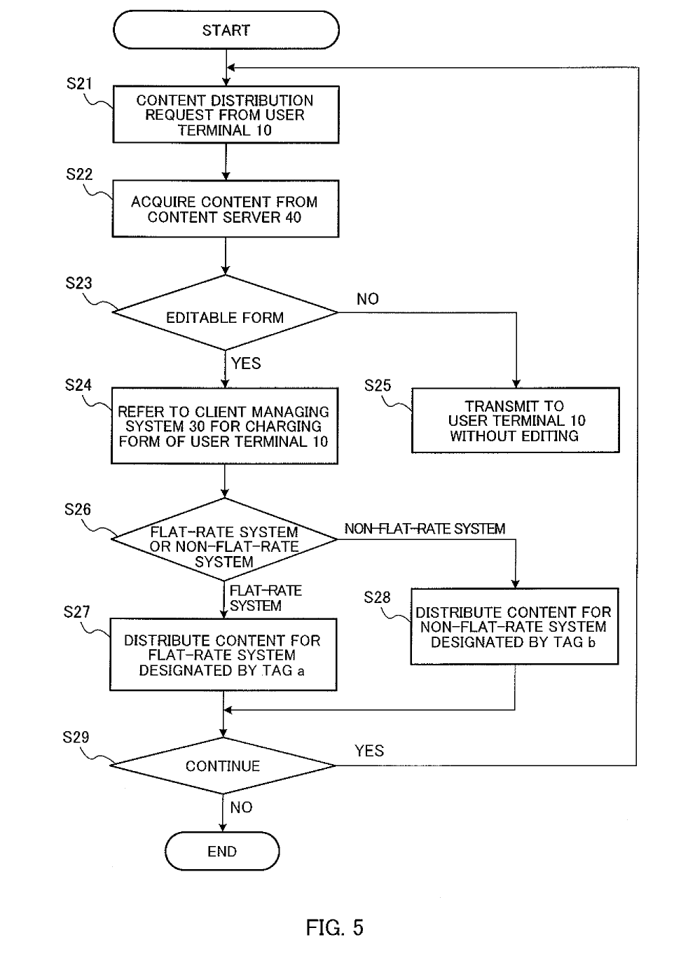

The content distribution method according to some embodiments will specifically be described below while focusing on the operation of the gateway server 20. FIG. 5 is a flowchart illustrating the operation of the gateway server 20 according to some embodiments.

As shown in FIG. 5, the content distribution request receiving section 21 receives a content distribution request for the content server 40 and the identification information of the user terminal 10 from the user terminal 10. The content distribution request receiving section 21 transfers the received content distribution request to the content server 40 (step S21).

The content acquiring section 22 acquires the content that is distributed from the content server 40 in accordance with the content distribution request in step S21 (step S22).

The content analyzing section 23 analyzes whether the content acquired in step S22 is in the editable form (step S23). More specifically, the content analyzing section 23 determines whether the content acquired in step S22 includes the tag “a” for the flat-rate system and tag “b” for the non-flat-rate system. When the content acquired in step S22 is the content in the editable form, the processing flow proceeds to step S24.

When the content acquired in step S22 is not the content in the editable form, the content distributing section 27 distributes the content acquired in step S22 to the user terminal 10 without any editing (step S25).

Meanwhile, when the content acquired in step S22 is the content in the editable form, the client managing system query section 24 refers to the client managing system 30 for the charging form of the user terminal 10, using as a key the identification information of the user terminal 10 received in step S21 (step S24).

The user attribute determining section 25 determines whether the charging form of the user terminal 10 referred in step S24 is the flat-rate system or the non-flat-rate system (step S26).

When the charging form of the user terminal 10 is the flat-rate system, the content editing section 26 edits the content acquired in step S22 so as to distribute the flat-rate content designated by the tag “a”. The content distributing section 27 transmits the edited content to the user terminal 10 (step S27).

When the charging form of the user terminal 10 is the non-flat-rate system, the content editing section 26 edits the content acquired in step S22 so as to distribute the non-flat-rate content designated by the tag “b”. The content distributing section 27 transmits the edited content to the user terminal 10 (step S28).

According to the content distribution system 1 according to some embodiments, the gateway server 20 edits content acquired from the content server 40 based on whether the charging form of the user terminal 10 is the flat-rate system or non-flat-rate system, and distributes the edited content to the user terminal 10. Therefore, it is possible to optimize the content to be distributed to the user terminal 10 on the network side in accordance with the charging form of the user terminal 10 without increasing the processing load on the content server 40 side. Further, the content server 40 is capable of distributing high-value added content with high capacity irrespective of whether or not the charging form of the user terminal 10 is the non-flat-rate system, and the gateway server 20 is capable of distributing high-value added content with high capacity to the user terminal 10, when the charging form of the user terminal 10 is the flat-rate system.

Moreover, according to the content distribution system 1 according to some embodiments, the gateway server 20 managed by the telecommunications carrier that is subscribed to by the user terminal 10 edits the content acquired from the content server 40 and distributes the edited content to the user terminal 10. Therefore, it is possible to distribute the optimal content under the initiative of the network side without the outside content provider who manages the content server 40 knowing the charging form involving the privacy of the user terminal 10.

Next, another embodiment describes an example where in the content distribution system 1, the gateway server 20 edits the content to distribute to the user terminal 10 based on whether or not the user's age of the user terminal 10 is a predetermined age or more, while focusing on the difference from the gateway server 20 in Embodiment 1.

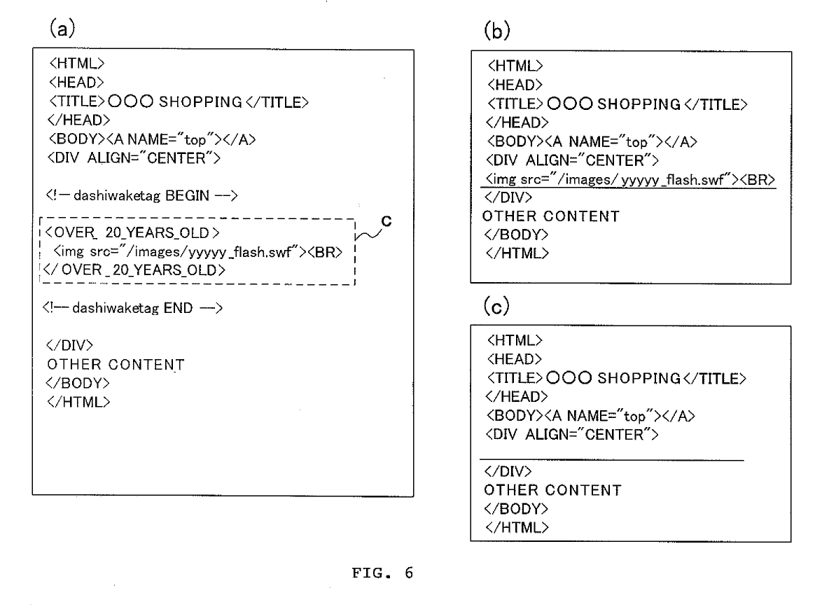

The content acquiring section 22 according to the present embodiment acquires content to be edited into content that includes information for a predetermined age targeted for a user of the predetermined age or more and content that does not include the information for the predetermined age. More specifically, as shown in FIG. 6(a), the content in the editable form according to Embodiment 2 includes a tag “c” to distribute the information for the predetermined age.

The client managing system query section 24 according to the present embodiment refers to the client managing system 30 for the user's age of the user terminal 10, instead of the charging form of the user terminal 10, using the identification information of the user terminal 10 as a key. The user attribute determining section 25 determines whether or not the user's age of the user terminal 10 acquired in the client managing system query section 24 is a predetermined age (for example, 20) or more. The user attribute determining section 25 determines to distribute the content that includes the information for predetermined age when the user's age of the user terminal 10 is the predetermine age or more, while determining to distribute the content that does not include the information for the predetermined age when the user's the age of the user terminal 10 is less than the predetermined age.

The content editing section 26 according to the present embodiment edits the editable content acquired from the content server 40 according to the determination result by the user attribute determining section 25. More specifically, when the user attribute determining section 25 determines to distribute the content that includes the information for the predetermined age, as shown in FIG. 6(b), the content editing section 26 edits the HTML file so as to distribute the information for the predetermined age (img src=“/images/yyyyy_flash.swf”) designated by the tag “c”. Meanwhile, when the user attribute determining section 25 determines to distribute the content that does not include the information for the predetermined age, as shown in FIG. 6(c), the content editing section 26 edits the HTML file so as not to distribute the information for the predetermined age (img src=“/images/yyyyy_swf”) designated by the tag “c”.

According to the content distribution system 1 according to Embodiment 2, the gateway server 20 is capable of editing the content acquired from the content server 40 based on the user's age of the user terminal 10, and distributing the edited content to the user terminal 10. Therefore, it is possible to optimize the content to be distributed to the user terminal 10 on the network side in accordance with the user's age of the user terminal 10 without increasing the processing load on the content server 40 side. Further, the content server 40 is capable of distributing various contents without concern for user's age of the user terminal 10.

Moreover, according to the content distribution system 1 according to the present embodiment, the gateway server 20 managed by the telecommunications carrier that is subscribed to by the user terminal 10 edits the content acquired from the content server 40 and distributes the edited content to the user terminal 10. Therefore, it is possible to distribute the optimal content under the initiative of the network side without the outside content provider who manages the content server 40 knowing the user's age involving the privacy of the user terminal 10.

Next, yet another embodiment describes an example where in the content distribution system 1, the gateway server 20 edits the content to distribute to the user terminal 10 based on whether or not a locating area of the user terminal 10 corresponds to a predetermined area, while focusing on the difference from the gateway server 20 in the previous embodiment.

The content acquiring section 22 according to the present embodiment acquires content to be edited into content that includes information for a predetermined area targeted for a user locating in the predetermined area and content that does not include the information for the predetermined area.

The user attribute determining section 25 according to the present embodiment determines whether or not the locating area of the user terminal 10 acquired in a terminal position managing system (not shown in the figure) corresponds to the predetermined area. When the locating area of the user terminal 10 corresponds to the predetermined area, the user attribute determining section 25 determines to distribute the content that includes the information for the predetermined area, while determining to distribute the content that does not include the information for the predetermined area when the locating area of the user terminal 10 does not correspond to the predetermined area.

In accordance with the determination result in the user attribute determining section 25, as in the previous embodiment, the content editing section 26 according to the present embodiment edits the editable content acquired from the content server 40 so as to or not to distribute the information for a predetermined area.

According to the content distribution system 1 according to the present embodiment, the gateway server 20 is capable of editing the content acquired from the content server 40 based on whether the locating area of the user terminal 10 is a predetermined area, and distributing the edited content to the user terminal 10. Therefore, it is possible to optimize the content to be distributed to the user terminal 10 on the network side in accordance with the locating area of the user terminal 10 without increasing the processing load on the content server 40 side. Further, the content server 40 is capable of distributing various contents without grasping the area of the user terminal 10.

The above-mentioned Embodiments describe examples where the client managing system query section 24 of the gateway server 20 inquires about the charging form and user's age of the user terminal 10, but other information on the user attribute managed by the client managing system 30 may be referred to edit the content based on the other user attribute except the charging form and user's age of the user terminal 10.

What is claimed is:

1. A relay server comprising:
a content acquiring section that acquires content in an editable form from a content server, in accordance with a content distribution request from a user terminal; and
a content distributing section that edits the content acquired by the content acquiring section based on an editing condition of the user terminal, and distributes the edited content to the user terminal.

2. The relay server according to claim 1, wherein the content acquiring section acquires content to be edited into content for a flat-rate system and content for a non-flat-rate system, and
wherein the content distributing section distributes the content for the flat-rate system to the user terminal when a charging form of the user terminal is the flat-rate system, while distributing the content for the non-flat-rate system to the user terminal when the charging form of the user terminal is the non-flat-rate system.

3. The relay server according to claim 2, wherein the content for the flat-rate system is a moving image, and the content for the non-flat-rate system is a still image.

4. The relay server according to claim 1, wherein the content acquiring section acquires content to be edited into content that includes information for a predetermined age targeted for a user of the predetermined age or more and content that does not include the information for the predetermined age, and
wherein the content distributing section distributes the content that includes information for the predetermined age to the user terminal when a user's age of the user terminal is the predetermined age or more, while distributing the content that does not include the information for the predetermined age when the user's age of the user terminal is less than the predetermined age.

5. The relay server according to claim 1, wherein the content acquiring section acquires content to be enabled into content that includes information for the predetermined area targeted for a user locating in the predetermined area and content that does not include the information for the predetermined area, and
wherein the content distributing section distributes the content that includes the predetermined area to the user terminal when a locating area of the user terminal corresponds to the predetermined area, while distributing the content that does not include the information for the predetermined area when the locating area of the user terminal does not correspond to the predetermined area.

6. A content distribution system comprising:
a user terminal that performs a content distribution request;
a content server that distributes content; and
a relay server that relays content transmitted from the content server to the user terminal,
wherein the content server distributes content in an editable form, in accordance with the content distribution request from the user terminal, and
wherein the relay server receives the content in the editable form from the content server, edits the content in the editable form based on an edit condition, and distributes the edited content to the user terminal.

7. A content distribution method comprising:
transmitting a content distribution request transmitted from a user terminal to a content server;
acquiring content in an editable form from the content server, in accordance with the content distribution request from the user terminal; and
editing the content acquired by the content acquiring section based on an editing condition of the user terminal, and distributing the edited content to the user terminal.
